(19) United States
(12) Patent Application Publication
(10) Pub. No.: US 2012/0249437 A1
(43) Pub. Date: Oct. 4, 2012

(54) Device and Method of Touch Control Feedback and Touch Control Display Device Using the Same

(76) Inventor: Tung-Ming Wu, New Taipei City (TW)

(21) Appl. No.: 13/231,964

(22) Filed: Sep. 14, 2011

(30) Foreign Application Priority Data
Mar. 28, 2011 (TW) 100110579

(51) Int. Cl. G06F 3/041

(52) U.S. Cl. 345/173

(57) ABSTRACT

A touch control feedback device of a touch control display device, for providing feedback to touching statuses of a user corresponding to the touch control display device, includes at least one vibrator for generating vibration, a detection unit for detecting the touching statuses of the user corresponding to the touch control display device to generate a detection result, and a control unit coupled between the detection unit and the at least one vibrator for adjusting a vibration characteristics of the at least one vibrator.

### BACKGROUND OF THE INVENTION

1. Field of the Invention

The present invention relates to a touch control feedback device, touch control feedback method and touch control display device, and more particularly, to a touch control feedback device, and related touch control feedback method and touch control display device capable of enhancing operation interactivity and novelty.

2. Description of the Prior Art

A touch control display device has advantages of convenient operation, fast reaction and small form factor. Therefore, touch control display devices have been widely incorporated into all kinds of consumer electronic products, e.g. personal digital assistants (PDA), smart mobile devices, notebook computers and points of sales (POS), etc. With advancement of touch technologies, multi-touch can now be implemented in touch control display devices, to provide more interesting modes of operations in conjunction with other devices.

For example, vibrators can be incorporated into touch control display devices, such that vibrations are generated as a form of tactile feedback when the user correctly performs operations. In this way, it is possible to provide the user with confirmation for correct operation, while enhancing interactivity and novelty of operation. However, such operation is limited to only two modes, i.e. the vibrator being on/off, which can be monotonous. Therefore, searching for various new ways of employing vibrators in touch control display devices to enhance novelty of operation has become a common goal in the industry.

### SUMMARY OF THE INVENTION

Therefore, it is a primary objective of the present invention to provide a touch control feedback device, touch control feedback method and touch control display device.

A touch control feedback device for a touch control display device, for providing feedback to touch statuses of a user corresponding to the touch control display device is disclosed. The touch control feedback device includes at least one vibrator, for generating vibration, a detection unit, for detecting the touch statuses of the user corresponding to the touch control display device, to generate a detection result, and a control unit, coupled between the detection unit and the at least one vibrator, for adjusting vibration characteristics of the at least one vibrator according to the detection result.

A touch control feedback method for a touch control display device, for providing feedback to touch statuses of a user corresponding to the touch control display device is disclosed. The touch control feedback method includes detecting the touch statuses of the user corresponding to the touch control display device, to generate a detection result, and generating a vibration and adjusting vibration characteristics of the vibration according to the detection result.

A touch control display device is disclosed. The touch control display device includes a touch control screen, for displaying a screen and receiving touch control commands from a user, and a touch control feedback device, for providing feedback to touch statuses of the user corresponding to the touch control display device, including at least one vibrator, for generating vibration, a detection unit, for detecting the touch statuses of the user corresponding to the touch control display device, to generate a detection result, and a control unit, coupled between the detection unit and the at least one vibrator, for adjusting vibration characteristics of the at least one vibrator according to the detection result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a touch control feedback device according to an embodiment of the invention.

FIG. 2 is a schematic diagram of the touch control feedback device shown in FIG. 1 employing a plurality of vibrators.

FIG. 3 is a schematic diagram of a touch control feedback process according to an embodiment of the invention.

### DETAILED DESCRIPTION

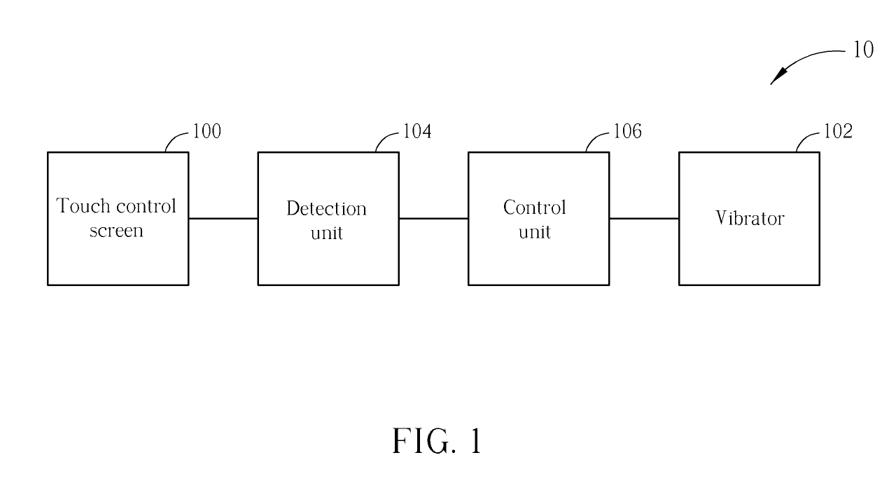

Please refer to FIG. 1, which is a schematic diagram of a touch control feedback device 10, according to an embodiment of the invention. The touch control feedback device 10 is for a touch control display device, and provides feedback to touch statuses of a user corresponding to a touch control screen 100 of the touch control display device. The touch control display device may be an independent electronic product, or a part of another device such as a smart phone, electronic book, etc. The touch control feedback device 10 includes a vibrator 102, a detection unit 104, and a control unit 106. The detection unit 104 is for detecting the touch statuses of the user corresponding to the touch control screen 100, e.g. quantity of touch points, sliding speed, speed of repeated clicking, etc. The control unit 106 adjusts vibration characteristics (e.g. vibration intensity, vibration speed, and vibration duration) of the vibrator 102 according to the detection result generated by the detection unit 104.

In short, in the touch control feedback device 10, operations of the vibrator 102 are not limited to simply switching between on/off states. Instead, different vibration characteristics of the vibrator 102, e.g. vibration intensity, vibration speed, and vibration duration, etc., may all be adjusted by the control unit 106, according to the different touch statuses. Moreover, please note that, ways in which the control unit 106 controls the vibrator 102 may also be suitably adjusted, according to system requirements, and are not limited to the above. For example, it is possible to further divide the vibration intensity of the vibrator 102 into three intensity levels, from weakest to strongest. As such, when the detection result of the detection unit 104 indicates that the user is only operating with one finger, the control unit 106 may control the vibrator 102 to generate vibration of the weakest intensity level; and when the detection result of the detection unit 104 indicates that the user is operating with two or three fingers, the control unit 106 may control the vibrator 102 to generate vibrations of a medium intensity level; and when the detection result of the detection unit 104 indicates that the user is operating with more than three fingers, the control unit 106 may control the vibrator 102 to generate vibration of the strongest intensity level. Similarly, it is also possible to adjust vibration intensity of the vibrator 102 according to the user's finger sliding speed, e.g. a faster sliding speed generates a stronger/weaker vibration. Alternatively, vibration intensity of the vibrator 102 may also be adjusted according to the user's clicking speed, e.g. faster clicking generates a stronger/weaker vibration.

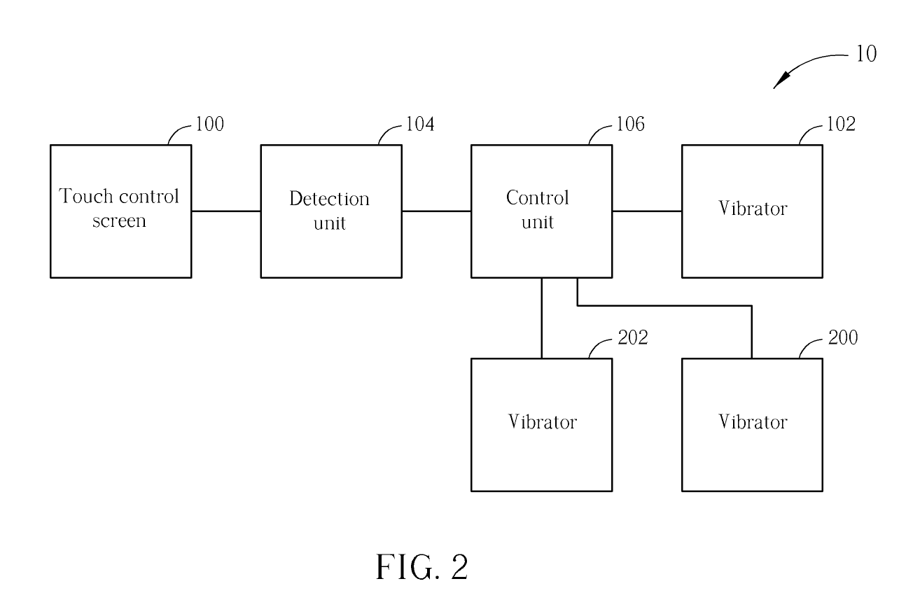

The aforementioned embodiment illustrates the concept of the invention that the vibration of the vibrator 102 is not limited to switching between on/off states only, but can be suitably adjusted according to the user's touch statuses. Therefore, apart from the aforementioned embodiment, any variations implementing this concept are within the scope of the invention. For example, in FIG. 1, the touch control feedback device 10 only generates vibration via the vibrator 102. However, it is also possible to generate vibration via one or more vibrators. For example, in FIG. 2, apart from the vibrator 102, the touch control feedback device 10 may further include vibrators 200 and 202. In such a case, the control unit 106 can adjust not only vibration characteristics of the vibrators 102, 200, and 202, respectively, according to the detection results of the detection unit 104, but also adjust a quantity of enabled vibrators within the vibrators 102, 200, and 202. Obviously, three vibrators are employed in FIG. 2 only as an example, and an arbitrary quantity of vibrators not limited thereto may be employed to suit different applications of the invention.

Moreover, in FIG. 1, the detection unit 104 and the control unit 106 are merely functional blocks representing any units with equivalent functionalities. In practice, the detection unit 104 and the control unit 106 may be implemented using software, firmware or hardware, etc., either through incorporation with existing components of the touch control display device, or via additional auxiliary components. For example, if an operational voltage or current of the vibrator 102 is directly supplied by the control unit 106, then the control unit 106 may directly control the vibration characteristics of the vibrator 102 via adjusting power supplied to the vibrator 102. Conversely, if the operational voltage or current of the vibrator 102 is provided by a power supply module, then the power supply module should be capable of providing a variable output power (e.g. via Pulse Width Modulation, PWM), such that the control unit 106 may adjust vibration characteristics of the vibrator 102 via the power supply module to implement aforementioned embodiments of the invention.

On the other hand, operations of the detection unit 104 are also not limited. For example, if the touch control display device is configured with a calculation unit for capturing raw data, then the detection unit 104 may determine touch statuses such as the quantity of touch points, sliding speed, clicking speed, etc., according to the raw touch data, wherein operations for determining touch statuses according to the raw touch data are well known to those with general skills in the art.

Therefore, the touch control display device or related electronic devices may generate different vibrations according to different touch statuses via the touch control feedback device 10 of the invention. In such a case, when the user clicks on the touch control display device, apart from generating a vibration, the touch control feedback device 10 may further adjust characteristics of the vibration, such as intensity, speed, durations, etc, according to the user's touch statuses, thereby enhancing interactivity and novelty for user operations.

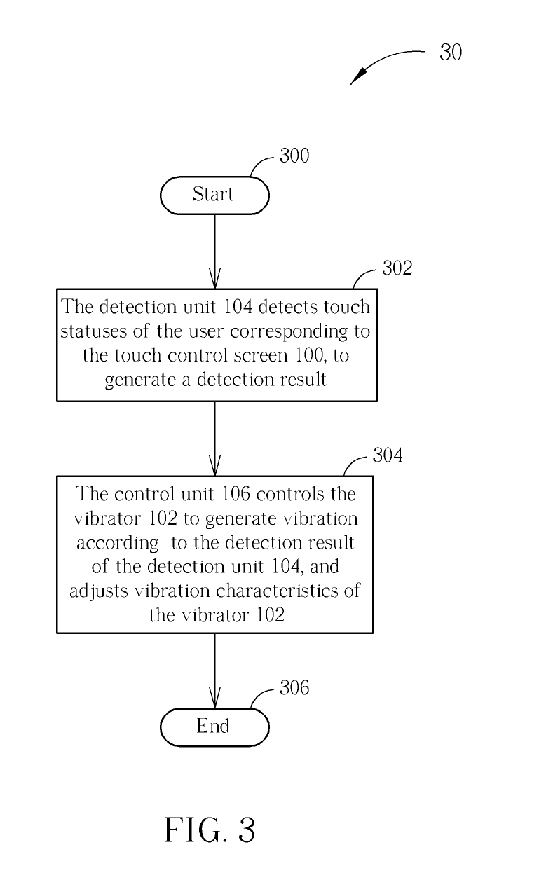

Operations of the touch control feedback device 10 may be further summarized into a touch control feedback process 30, as shown in FIG. 3. The touch control feedback process 30 includes the following steps:

Step 300: Start.

Step 302: The detection unit 104 detects touch statuses of the user corresponding to the touch control screen 100, to generate a detection result.

Step 304: The control unit 106 controls the vibrator 102 to generate vibration according to the detection result of the detection unit 104, and adjusts vibration characteristics of the vibrator 102.

Step 306: End.

Please refer to the aforementioned for detailed operations of the touch control feedback process 30.

Conventional touch control display devices which utilize vibration as feedback have only two modes of operation, i.e. on or off, and this can be monotonous for user experience. Comparatively, the invention further allows vibration characteristics such as intensity, speed, duration, etc. to be adjusted according to the user's touch statuses on the touch control display device, thereby enhancing interactivity and novelty of operation.

In summary, the invention is capable of adjusting vibration characteristics such as intensity, speed, duration, etc., according to the user's touch statuses corresponding to the touch control display device, thus enhancing interactivity and novelty of operation.

Those skilled in the art will readily observe that numerous modifications and alterations of the device and method may be made while retaining the teachings of the invention.

What is claimed is:

1. A touch control feedback device for a touch control display device, for providing feedback to touch statuses of a user corresponding to the touch control display device, the touch control feedback device comprising:
at least one vibrator, for generating vibration;
a detection unit, for detecting the touch statuses of the user corresponding to the touch control display device, to generate a detection result; and
a control unit, coupled between the detection unit and the at least one vibrator, for adjusting vibration characteristics of the at least one vibrator according to the detection result.

2. The touch control feedback device of claim 1, wherein the vibration characteristics of the at least one vibrator are selected from vibration intensity, vibration speed and vibration duration.

3. The touch control feedback device of claim 1, wherein the detection result generated by the detection unit comprises quantity of touch points, sliding speed or speed of repeated clicks of the user corresponding to the touch control display device.

4. The touch control feedback device of claim 1, wherein when a quantity of the at least one vibrator is greater than one, the control unit further adjusts a quantity of vibrators generating vibrations within the at least one vibrator according to the detection result.

5. The touch control feedback device of claim 1, further comprising a power supply module, for providing power to the at least one vibrator, wherein the control unit adjusts the vibration characteristics of the at least one vibrator via the power supply module.

6. A touch control feedback method for a touch control display device, for providing feedback to touch statuses of a user corresponding to the touch control display device, the touch control feedback method comprising:
detecting the touch statuses of the user corresponding to the touch control display device, to generate a detection result; and
generating a vibration and adjusting vibration characteristics of the vibration according to the detection result.

7. The touch control feedback method of claim 6, wherein the vibration characteristics of the vibration are selected from vibration intensity, vibration speed and vibration duration.

8. The touch control feedback method of claim 6, wherein the detection result comprises quantity of touch points, sliding speed or speed of repeated clicks of the user corresponding to the touch control display device.

9. The touch control feedback method of claim 6, further comprising generating a plurality of vibrations, and adjusting a plurality of vibration characteristics of the plurality of vibrations according to the detection result.

10. A touch control display device, comprising:
a touch control screen, for displaying a screen and receiving touch control commands from a user; and
a touch control feedback device, for providing feedback to touch statuses of the user corresponding to the touch control display device, comprising:
at least one vibrator, for generating vibration;
a detection unit, for detecting the touch statuses of the user corresponding to the touch control display device, to generate a detection result; and
a control unit, coupled between the detection unit and the at least one vibrator, for adjusting vibration characteristics of the at least one vibrator according to the detection result.

11. The touch control display device of claim 10, wherein the vibration characteristics of the at least one vibrator are selected from vibration intensity, vibration speed and vibration duration.

12. The touch control display device of claim 10, wherein the detection result generated by the detection unit comprises quantity of touch points, sliding speed or speed of repeated clicks of the user corresponding to the touch control screen.

13. The touch control display device of claim 10, wherein when a quantity of the at least one vibrator is greater than one, the control unit further adjusts a quantity of vibrators generating vibrations within the at least one vibrator according to the detection result.

14. The touch control display device of claim 10, further comprising a power supply module, for providing power to the at least one vibrator, wherein the control unit adjusts the vibration characteristics of the at least one vibrator via the power supply module.
